(19) United States
(12) Patent Application Publication
(10) Pub. No.: US 2015/0302064 A1
(43) Pub. Date: Oct. 22, 2015

(54) TAG-BASED CONTENT EXCLUSION

(71) Applicant: Adobe Systems Incorporated, San Jose, CA (US)

(72) Inventor: Gilles Knobloch, Wahlbach (FR)

(73) Assignee: ADOBE SYSTEMS INCORPORATED, San Jose, CA (US)

(21) Appl. No.: 14/257,508

(22) Filed: Apr. 21, 2014

(51) Int. Cl. G06F 17/30; G06F 3/0482; H04L 29/08

(52) U.S. Cl. CPC G06F 17/30554; H04L 67/02; G06F 3/0482

(57) ABSTRACT

Techniques are provided for filtering digital content based on subject matter exclusion tags associated with a target audience. A content author can associate authored content with tag metadata that is representative of the subject matter of the authored content. When searching for content, such as by submitting a query to a search engine, a content consumer can designate exclusion tags corresponding to subject matter that is not of interest. Where one of the content consumer's designated exclusion tags corresponds to the tag metadata designated by a content author for a particular content item, the consumer can be assumed to have no interest in that content item. A content server can prevent such content from being served to the content consumer. This allows the content consumer to more specifically tailor the received content to his/her specific interests, and to specify customizations that exclude unwanted content from content retrieval operations.

### FIELD OF THE DISCLOSURE

This disclosure relates generally to the delivery of digital content to a target audience, and more specifically, to techniques for filtering digital content based on one or more subject matter tags associated with a target audience.

### BACKGROUND

With a continually expanding footprint that now exceeds two billion users, the Internet has become an increasingly important medium for information exchange. Businesses, governments, nonprofit organizations, informal social groups, and individuals routinely use the Internet to disseminate information, conduct advertising and public relations campaigns, engage in commercial or other transactions, and otherwise communicate with each other. In addition, vast databases of information ranging from satellite imagery to sports statistics are compiled and maintained with minimal ongoing human involvement. As a result, an unprecedented amount of digital information is now available on the Internet. This information can be disseminated and accessed using a wide variety of resources that comprise various aspects of the Internet, such as the World Wide Web (WWW), instant messaging, web feeds, electronic mail, social networks, and voice over Internet Protocol (VoIP) services. Search engines have made it possible for users to search through the vast quantities of information available via the Internet with the tap of a finger or even a simple voice query, thereby providing fantastic opportunities for people seeking information from known and unknown sources across the world.

### BRIEF DESCRIPTION OF THE DRAWINGS

FIG. 1 is a block diagram schematically illustrating selected components of a content consumption device, a content server, and a content creation device which, in certain embodiments, can interact with each other to filter digital content based on one or more subject matter tags associated with a target audience.

FIG. 2 is a flowchart illustrating an example method of associating metadata tags with generated content in a way that facilitates adaptation of the content for a particular target audience.

FIG. 3 is a flowchart illustrating an example method of serving content to a target audience, wherein the served content is selected based on subject matter tags associated with the target audience.

FIG. 4 is a data flow diagram schematically illustrating an example method of delivering content that has been adapted for a target audience based on correlation of tag metadata provided by a content author with exclusion tags provided by a content consumer.

FIG. 5A illustrates an example embodiment of a user interface that a content consumer can use to define exclusion tags which form the basis for content filtering in a news aggregator.

FIG. 5B illustrates the example user interface of FIG. 5A wherein content displayed in the news aggregator has been filtered based on a user-defined content exclusion tag.

### DETAILED DESCRIPTION

As the volume of information available via the Internet continues to grow, the challenge of locating a particular desired piece of information has grown as well. To some extent, search engines address this challenge by providing links to webpages or other networked resources which correspond to a user's submitted query. But while search engines can efficiently identify specific resources which correlate to a search query, the mere existence of such correlation does not necessarily mean that the search results accurately reflect the underlying interests which motivated the user's search in the first place. As a result, a number of techniques have been developed to personalize search results based on the interests of the user submitting the search query. For instance, existing search engines can be configured to highlight, emphasize, or otherwise increase the ranking of certain search results based on characteristics that are particular to the user submitting the search query. Examples of such characteristics include a user's geographic location, a user's browsing history, or a list of interests specified in a user profile. Customizations such as these facilitate identification and inclusion of search results that may more closely correlate to a user's interests. However, existing systems do not allow a user to specify customizations that facilitate exclusion of search results or other content items that do not correlate to a user's interests. In general, existing systems are not well-suited for excluding a customized subset of results which would otherwise be generated as a result of a search query or other information retrieval operation.

Thus, and in accordance with certain of the embodiments disclosed herein, techniques are provided for filtering digital content based on subject matter exclusion tags associated with a target audience. For example, in certain embodiments a content author can associate authored content with tag metadata that is representative of the subject matter of the authored content. Likewise, when searching for content, such as by submitting a query to a search engine, a content consumer can designate one or more exclusion tags corresponding to subject matter in which the content consumer has no interest. Where one of the content consumer's designated exclusion tags matches or otherwise corresponds to the tag metadata designated by a content author for a particular content item, the consumer can be assumed to have no interest in that content item. A content server can therefore be configured to filter, block, or otherwise prevent such content from being served to the content consumer. This allows the content consumer to more specifically tailor the received content to his/her specific interests in a way that is impossible using existing systems. In particular, while existing systems allow a user to focus search results on a certain subject matter area, such systems do not allow a user to specify customizations that exclude unwanted content from search results or other content retrieval operations. Numerous configurations and variations of the content delivery techniques described herein will be apparent in light of this disclosure.

For instance, in one example embodiment a content author generates a news article describing the upcoming passing of Halley's Comet. The content author associates the article with metadata tags such as “Halley”, “comet”, and “astronomy”. The article is then published to a content server from which it can be indexed by search engines, retrieved by news aggregators, and/or retrieved by individual web browsers. For example, a news aggregation service configured in accordance with certain embodiments allows a content consumer to specify one or more exclusion tags corresponding to topics in which the content consumer is not interested. In one embodiment the exclusion tags are specified by free-form textual input provided by the consumer, while in another embodiment the exclusion tags are chosen from a list of tags associated with available content. In yet another embodiment the user can apply content filtering based on a previously list of exclusion tags set by the content author, the news aggregator, or by the content consumer. In response to the content consumer's identification of an exclusion tag, the news aggregation service is configured to modify the content which is made available to the content consumer. Thus, for example, where the aforementioned article on Halley's Comet might normally be sufficiently popular to be included in a listing of top news stories, upon a particular content consumer's designation of “astronomy” as an exclusion tag, the article is removed from the listing of top stories served to that particular consumer. This application therefore provides the consumer with an easy way to, for instance, filter a news feed so as to avoid seeing news stories which are not of interest. Such techniques may be particularly helpful in this context since they allow a user who is not interested in a popular news story to avoid scrolling through large quantities of content which are not of interest.

As used herein, the term “content” refers, in addition to its ordinary meaning, to information intended for direct or indirect consumption by a user, organization, or other human- or computer-controlled entity. For example, the term content encompasses information directly consumed by a user such as when it is displayed on a display device or printed on a piece of paper. The term content also includes information that is not specifically intended for display, and therefore also encompasses items such as software, software applications, mobile applications, executable instructions, scripts, hyperlinks, addresses, pointers, metadata, and formatting information. Thus, as used herein, the term “content item” may not necessarily refer to the content item itself, but instead may refer to other data associated with the content item, such as a network address. The use of the term content is therefore independent of (a) how the content is presented to a user for consumption and (b) how the content is created and/or rendered. The term “digital content” refers to content which is encoded in binary digits (for example, zeroes and ones). In the context of applications involving digital computers, the terms “content” and “digital content” are thus often used interchangeably. The term “targeted content” refers to content which is targeted or otherwise intended, optimized, or prepared for consumption by a specific target audience or other group. The term “content segment” refers to a subset or portion of a larger collection of content, for example, such that content provided by a news aggregation service may comprise different content segments corresponding to local news, international news, sports news, and so forth.

As used herein, the term “content author” refers, in addition to its ordinary meaning, to a person, organization, or other human- or computer-controlled entity that generates, manages, administers, imports, or otherwise influences content and/or functionality provided by a computer system. In general, a content author can be understood as representing the source of a document in a workflow. It will be appreciated that a content author may not necessarily be the creator or generator of a particular content item, but rather may simply be a user or entity that initiates a workflow by sending a content item to another entity for subsequent processing. It will also be appreciated that the term content author is not limited to people or users, but may also encompasses entities, organizations, or workstations which originate content as part of a workflow. The terms “content author” and “author” are used interchangeably herein.

As used herein, the term “tag” refers, in addition to its ordinary meaning, to a keyword, term, or phrase assigned to a segment of information, such as a content item. A tag can thus be understood as a type of metadata that can be used to describe or otherwise classify a content item. Such metadata can be incorporated into the corresponding content item itself, or may be stored in a separate data structure which references, or is referenced by, the corresponding content item. In certain applications a tag can be assigned by a content author, based on either a particular user's judgment or an automated algorithm. A given content item may therefore be associated with multiple tags assigned by multiple entities. Outside the context of content authoring and management, tags may also be specified by a content consumer searching for content items associated with a specified tag. In this context, the specified tag will not necessarily be associated with a particular content item, but rather can be understood as an input provided by a content consumer. A variety of different types of tags can be specified by a content consumer. For example, an “exclusion tag” can be understood as being associated with a subset of content which the content consumer wishes to exclude or otherwise distinguish from other content. Likewise, a “targeted content tag” can be understood as being associated with content which a content consumer wishes to target for inclusion with other content. Thus, in general, a content author can be understood as specifying generic tags which are associated with authored or managed content, while a content consumer can be understood as specifying targeted content tags or content exclusion tags which are later used to identify particular content.

As used herein, the term “target audience” refers, in addition to its ordinary meaning, to one or more content consumers for which content is specifically intended or adapted. A target audience may therefore comprise a single content consumer, a small group of content consumers, or a broad market segment defined by a demographic or other characteristic. The following are examples of a target audience: an individual content consumer, a group of customers enrolled in a focus group, and residents of a particular city. Content may be adapted for a target audience using a variety of techniques, including by removing content in which the target audience is believed to have little or no interest. This belief can be based on an expressed preference of the target audience. For example, a target audience comprising vegetarians may use content exclusion tags to configure their news aggregators to remove news articles relating to licensing requirements for the upcoming deer hunting season. Thus a target audience can be defined according to a variety of different criteria, including demographic data provided in a user profile, content exclusion tags provided via a content consumption user interface, or data harvested from browser cookies stored on one or more content consumers' computer computers.

System Architecture

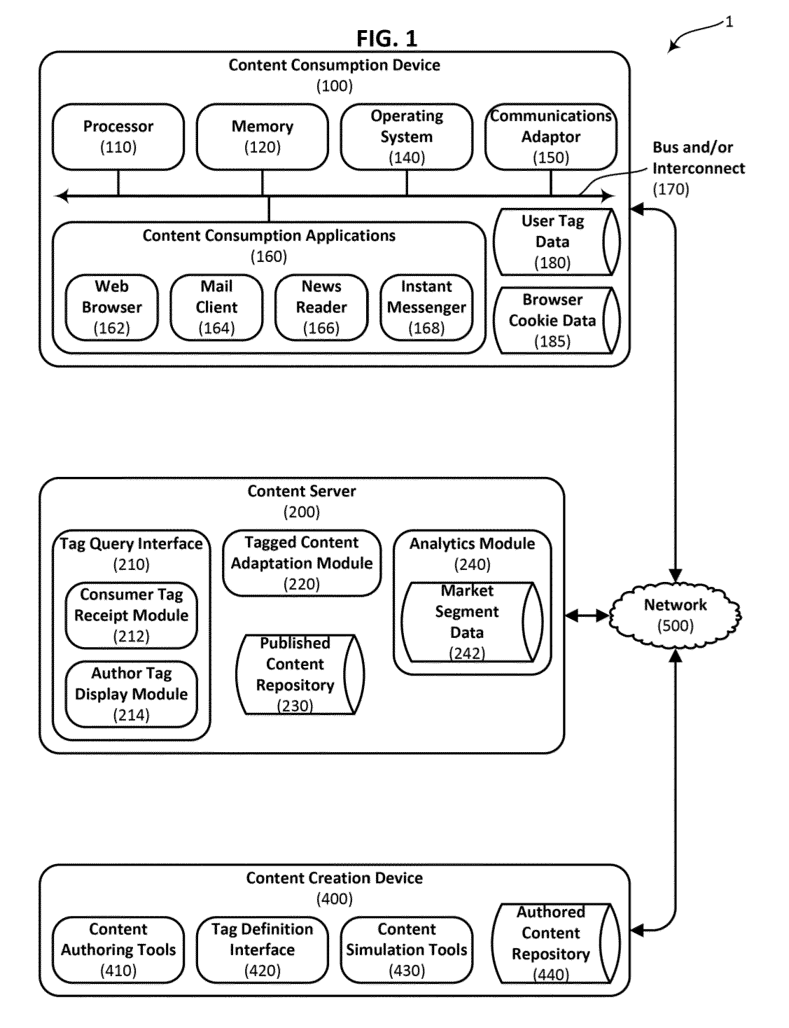

FIG. 1 is a block diagram schematically illustrating selected components of a networked computer system 1 that can be used to filter digital content based on one or more subject matter tags associated with a target audience. Computer system 1 includes a content consumption device 100 that is configured to (a) provide a content consumer with the ability to request content from a content server 200 and (b) receive and render the requested content. Computer system 1 also includes a content creation device 400 that is configured to provide a content author with the ability to generate and publish content to content server 200. Because content consumption device 100 can be understood as being associated with, providing functionality to, or otherwise representing a content consumer, the phrases “content consumption device” and “content consumer” are used interchangeably herein. Likewise, because content creation device 400 can be understood as being associated with, providing functionality to, or otherwise representing a content author, the phrases “content creation device” and “content author” are also used interchangeably herein. Content consumer 100, content server 200, and content author 400 can communicate and interact with each other, and optionally with other devices and/or resources, via a network 500. Network 500 may be a local area network (such as a home-based or office network), a wide area network (such as the Internet), or a combination of such networks, whether public, private or both. In some cases access to resources on a given network or computing system may require credentials such as usernames, passwords, and/or any other suitable security mechanism.

Content consumption device 100, content creation device 400, and content server 200 can be implemented in a generalized client-server computing environment. Such an implementation allows content consumer 100 to access content that is managed and/or generated by content author 400. Thus in certain embodiments content server 200 comprises a single stand-alone server configured to host content published by content author 400 and respond to requests for hosted content from content consumer 100. In other embodiments content server 200 comprises a geographically distributed network of hundreds or thousands of servers capable of hosting content authored by an even larger number of content authors, and delivering content to a similarly large (or even larger number) of content consumers. Content consumption device 100 and content creation device 400 can be implemented in embodiments specific to the WWW, such as where content server 200 comprises a news aggregator that receives content from content author 400 and that serves content to content consumer 100 via a news portal. However other embodiments can be implemented in other applications, such as the delivery of a news feed to an email distribution list or the posting of content to a social networking service.

The functionality of the various components and subcomponents comprising computer system 1 will be described in turn, although it will be appreciated that alternative embodiments may include additional or fewer components, and therefore may not be limited to any particular set of components or any particular hardware configuration. More specifically, in other embodiments computer system 1 optionally includes additional or alternative components and/or subcomponents that can be configured to provide other content distribution functionality depending on the needs of a particular application. For example, such additional or alternative components and/or subcomponents may take the form of one or more server-side modules which interact with and/or respond to user input received from content consumer 100 and/or content author 400.

Still referring to the example embodiment illustrated in FIG. 1, content consumption device 100 may comprise, for instance, one or more devices selected from a desktop or laptop computer, a workstation, a tablet computer, a smartphone, a set-top box, a smart television, or any other such computing device. A combination of different devices may be used in certain embodiments. In the illustrated embodiment, content consumption device 100 includes a processor 110, a memory 120, an operating system 140, a communications adaptor 150, and one or more content consumption applications 160. As can be further seen, a bus and/or interconnect 170 is also provided to allow for intra-device communications using, for example communications adaptor 150. Other componentry and modules typical of a computing system, such as input devices, output devices, and user interface modules are not shown but will be readily apparent in light of this disclosure. Thus it will be appreciated that the embodiments disclosed herein are not intended to be limited to the particular configuration of content consumption device 100 illustrated in FIG. 1, and that other configurations and subcomponents can be used in other embodiments.

Processor 110 can be any suitable processor, and may include one or more coprocessors or controllers, such as an audio processor or a graphics processing unit, to assist in control and processing operations associated with content consumption device 100. Memory 120 can be implemented using any suitable type of digital storage, such as one or more of a disk drive, a universal serial bus (USB) drive, flash memory, and/or random access memory. Operating system 140 may comprise any suitable operating system, such as Google Android (Google Inc., Mountain View, Calif.), Microsoft Windows (Microsoft Corp., Redmond, Wash.), or Apple OS X (Apple Inc., Cupertino, Calif.). As will be appreciated in light of this disclosure, the techniques provided herein can be implemented without regard to the particular operating system provided in conjunction with content consumption device 100, and therefore may also be implemented using any suitable existing or subsequently-developed platform. Communications adaptor 150 can be any appropriate network chip or chipset which allows for wired and/or wireless connection to network 500 or peripheral hardware such that content consumption device 100 can communicate with other local and/or remote computing systems, servers, peripheral hardware devices and/or resources. In certain embodiments communications between content consumption device 100 and content server 200 conform to the hypertext transfer protocol (HTTP).

One or more content consumption applications 160 can be used to facilitate the rendering and consumption of content by content consumer 100. Example content consumption applications 160 include a web browser 162, a mail client 164, a news reader 166, and an instant messenger 168. Additional, alternative, or fewer applications can be used in other embodiments. In certain embodiments, the one or more content consumption applications 160 are capable of generating a user interface that allows content consumer 100 to define particular content segments which are of interest or which are not of interest. Such definitions may comprise, for example, designation of targeted content tags and/or content exclusion tags. Such definitions may additionally or alternatively comprise user profile information that specifies demographic, interest, or other information from which the content consumer's interests may be discerned, predicted, or otherwise inferred. A user interface can also be configured to display information with respect to content tags associated with content which is provided to, or which is available to be provided to, content consumer 100 via content consumption applications 160. Content consumer 100 can use such information to make decisions with respect to the designation of targeted content tags and/or content exclusion tags. In some cases multiple content consumption applications 160 can share a common user interface.

In certain embodiments one or more content consumption applications 160 can be configured to generate data which can be stored by content consumption device 100 for future use. For example, web browser 162 can be configured to receive one or more user-designated content exclusion tags which define a particular content segment in which content consumer 100 has no interest. Web browser 162 can likewise be configured to receive one or more user-designated targeted content tags which define a particular content segment in which content consumer 100 is interested. In either case, such user-designated tags can be understood as comprising user tag data 180 which is stored in memory 120. Likewise, web browser 162 can also be configured to store information, such as browser cookie data 185, which content server 200 can use to make predictions with respect to what types of content may be interesting or not interesting to content consumer 100. In a modified embodiment user tag data 180 and/or browser cookie data 185 can be stored external to content consumption device 100, such as on an external drive or in a cloud storage repository. Just as multiple content consumption applications 160 can share a common user interface, content consumption applications 160 can jointly gather and leverage user tag data 180, browser cookie data 185, and/or other date from which the interests of content consumer 100 can be derived.

As disclosed herein, in certain embodiments content consumption device 100, content creation device 400, and content server 200 are implemented in a client-server computing environment. In such embodiments, content server 200 can be configured to receive and respond to requests received from one or more content consumption devices 100 to provide content that is hosted or otherwise made available via server 200. Such content may be stored, for example, in a published content repository 230 hosted by server 200. Thus, in applications where content consumer 100 requests content relating to particular subject matter, or requests that content relating to particular subject matter be excluded from content served to content consumer 100, a tagged content adaptation module 220 can be configured to modify or otherwise adapt content for a particular target audience before such content is served from content server 200 to content consumer 100. Such modification or adaption of content can be based on information characterizing the target audience, such as the aforementioned user tag data 180 and browser cookie data 185.

As set forth herein, user tag data 180 can be used to adapt content for delivery to a particular target audience, for example by removing content that is not of interest to the target audience. In certain embodiments content server 200 is configured to provide a tag query interface 210 that is capable of gathering user tag data 180 upon which the aforementioned content adaption can be based. In particular, tag query interface 210 can be provided to one or more content consumption applications 160 where it can be rendered and made available for user interaction. In such embodiments tag query interface 210 may comprise a consumer tag receipt module 212 that is configured to receive consumer-designated content exclusion tags and/or targeted content tags. Such tags can be specified by free-form textual input provided by content consumer 100. Tag query interface 210 may additionally or alternatively comprise an author tag display module 214 that is configured to display author-designated tags associated with content managed by content server 200, such as the content stored in published content repository 230. In such embodiments author tag display module 214 can be further configured to receive a user selection from the displayed tags, thereby enabling the user to choose a particular tag from a list of available tags. Thus tag query interface 210 is capable of receiving from content consumer 100 (a) free-form textual input that defines a tag and/or (b) a selection of an author-generated tag.

Content server 200 optionally includes an analytics module 240. Analytics module 240 can be configured to allow market segments to be defined based on data that characterizes a target audience. Such data can be derived from, for example, user tag data 180 and/or browser cookie data 185. For instance, user tag data 180 and/or browser cookie data 185 may characterize a particular content consumer as being not interested in opposition party politics, such as based on a content exclusion tag set by the consumer that specifies the name of the opposition party. In this case, analytics module 240 can be configured to assign this consumer to a market segment associated with an interest in ruling party politics. In other embodiments a content administrator or a content author can (a) review user tag data 180, browser cookie data 185, and/or other data characterizing a target audience, and (b) define a customized market segment corresponding to the target audience. More generally, analytics module 240 can be understood as allowing a content author to not only target content consumers based on their dislikes, but also to draw inferences with respect to their likes based on their known dislikes. The resulting market segment data 242, regardless of whether based on logic provided by analytics module 240 and/or based on a content author's inferences, can be stored by analytics module 240. Thus, when future members of the identified market segments request content from content server 200, tagged content adaptation module 220 can adapt the served content appropriately.

Referring still to the example embodiment illustrated in FIG. 1, computer system 1 further comprises content creation device 400. Content creation device 400 may comprise, for instance, one or more devices selected from a desktop or laptop computer, a workstation, a tablet computer, a smartphone, a set-top box, a smart television, or any other such computing device. A combination of different devices may be used in certain embodiments. Like content consumption device 100, content creation device 400 may also include components such as a processor, a memory, an operating system, a communications adaptor, and a bus and/or interconnect. Such componentry is not illustrated in FIG. 1 for clarity. Such componentry and other modules typical of a computing system, including input devices, output devices, and user interface modules, are not illustrated but will be readily apparent in light of this disclosure. However, FIG. 1 does illustrate that in certain embodiments content creation device 400 further includes content authoring tools 410, a tag definition interface 420, content simulation tools 430, and an authored content repository 440.

Content authoring tools 410 may comprise any of a variety of software applications or other resources which facilitate the generation and management of content. Such tools can be used, for example, to generate content, build websites incorporating the generated content, and analyze how visitors browse such a website and the content provided therein. Such tools may also include tools specifically configured for authoring targeted content such as banner advertisements, embedded advertisements, and sponsored search results. In general, content authoring tools 410 can be provided by any of a variety of existing content management systems.

Examples of commercially available content management systems include Adobe Experience Manager (Adobe Systems Incorporated, San Jose, Calif.) and Microsoft SharePoint (Microsoft Corporation, Redmond, Wash.). In certain embodiments the content generated and/or managed by content authoring tools 410 is stored in authored content repository 440, although in other embodiments such content can be stored external to content generation device 400, such as on an external drive or in a cloud storage repository.

In certain embodiments content authoring tools 410 can be integrated with a tag definition interface 420 that is configured to gather tag data specified by a content author. In particular, upon authoring, modifying, importing or reviewing content, content author 400 can specify tag metadata associated with such content using tag definition interface 420. Unlike tags designed by content consumer 100, the tag metadata provided by content author 400 need not be designated as targeted content tags or content exclusion tags (although such a distinction may be drawn in alternative embodiments). For example, a news article describing the upcoming passing of Halley's Comet may be tagged with the terms “Halley”, “comet” and “astronomy”. Such tagging may be performed manually based on the content author's judgment, although in alternative embodiments tag definition interface 420 can be configured to automatically analyze a content item and determine how it should be tagged using a suitable contextual analysis methodology. One example of such a textual analysis methodology is disclosed in U.S. patent application Ser. No. 14/054,351 (filed 15 Oct. 2013).

Content generation device 400 may also optionally include one or more content simulation tools 430 which can be configured to provide a simulation of how authored content will appear after being processed by content server 200, are more particularly, by tagged content adaptation module 220. Such tools allow content author 400 to understand how certain content tagging strategies may affect the way in which content is rendered for content consumer 100. This is particularly helpful for a content author generating a website comprising multiple webpages having dynamically generated content which may be substantially affected in response to application of one or more content exclusion tags. That is, in some cases an entire website structure may be modified in response to filtering based on one or more content exclusion tags, such that entire pages may be hidden from the content consumer.

For example, a content author generating a website devoted to Major League Baseball may have entire pages dedicated to particular baseball teams. The content author may leverage services provided by content simulation tools 430 to explore how the website as a whole would respond to, for example, application of a content exclusion tag comprising the term “Boston Red Sox”. For example, the content author could configure the website to hide or otherwise diminish to prominence of the Red Sox page based on application of such a content exclusion tag. Thus, in general, content simulation tools 430 can be understood as enabling content author 400 to simulate how content will appear after it has been adapted for consumption by a particular market segment.

The embodiments disclosed herein can be implemented in various forms of hardware, software, firmware, and/or special purpose processors. For example, in one embodiment a non-transitory computer readable medium has instructions encoded thereon that, when executed by one or more processors, cause one or more of the digital content filtering methodologies disclosed herein to be implemented. The instructions can be encoded using one or more suitable programming languages, such as C, C++, object-oriented C, JavaScript, Visual Basic .NET, BASIC, or alternatively, using custom or proprietary instruction sets. Such instructions can be provided in the form of one or more computer software applications and/or applets that are tangibly embodied on a memory device, and that can be executed by a computer having any suitable architecture. In one embodiment the system can be hosted on a given website and implemented using JavaScript or another suitable browser-based technology.

The functionalities disclosed herein can optionally be incorporated into software applications other than those specifically configured for the delivery and consumption of rendered content. For example, a word processing application may include an online help module configured to display context-appropriate help information to a user. In some cases the help module can be configured to adapt the help information based on content exclusion tags that are derived from the context in which the user invokes the help module. The computer software applications disclosed herein may therefore include a number of different modules, sub-modules, or other components of distinct functionality that can provide information to, or receive information from, still other components and/or services. These modules can be used, for example, to communicate with input and/or output devices such as a pointer device, a display screen, a touch sensitive surface, a printer, and/or any other suitable input/output device. Other components and functionality not reflected in the illustrations will be apparent in light of this disclosure, and it will be appreciated that the embodiments disclosed herein are not intended to be limited to any particular hardware and/or software configuration. This in other embodiments the configuration of computer system 1 illustrated in FIG. 1 may comprise additional, fewer, or alternative components.

The aforementioned non-transitory computer readable medium may be any suitable medium for storing digital information, such as a hard drive, a server, a flash memory, and/or random access memory. In alternative embodiments the computer and/or modules disclosed herein can be implemented with hardware, including gate level logic such as a field-programmable gate array (FPGA), or alternately, a purpose-built semiconductor such as an application-specific integrated circuit (ASIC). Still other embodiments may be implemented with a microcontroller having a number input/output ports for receiving and outputting data, and a number of embedded routines for carrying out the various functionalities disclosed herein. It will be apparent that any suitable combination of hardware, software, and firmware can be used, and that the various embodiments disclosed herein are not intended to be limited to any particular system architecture.

Methodology and User Interface

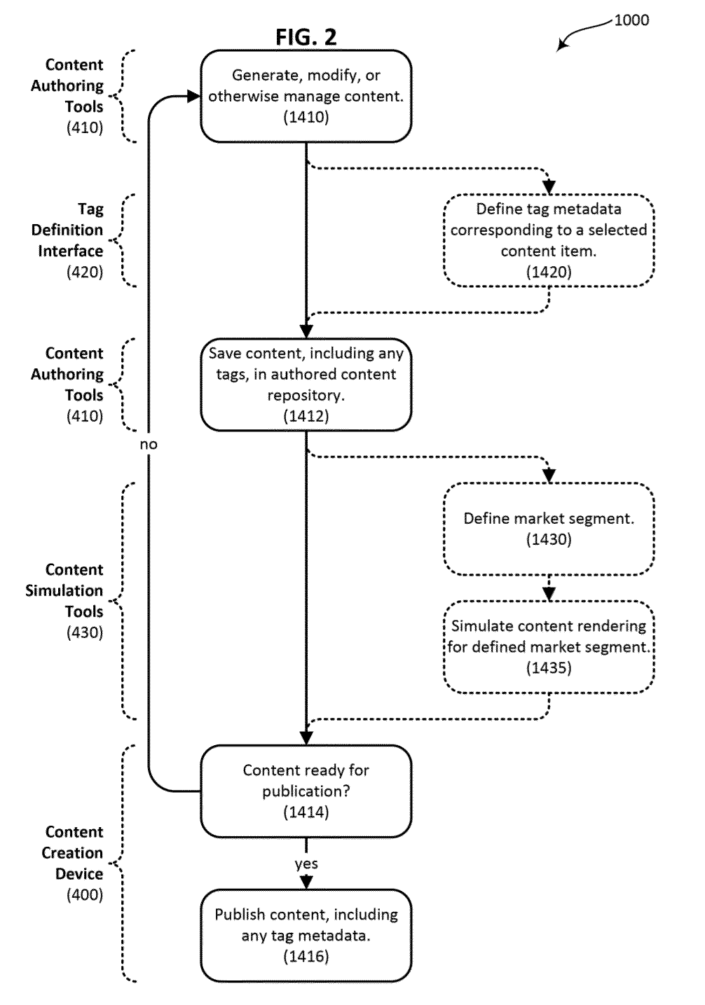

FIG. 2 is a flowchart illustrating an example method 1000 of associating metadata tags with generated content in a way that facilitates adaptation of the content for a particular target audience. As can be seen, this example methodology includes a number of phases and sub-processes, the sequence of which may vary from one embodiment to the next. However, when considered in the aggregate, these phases and sub-processes form a complete content generation functionality that is responsive to user commands in accordance with certain of the embodiments disclosed herein. This methodology and its variants can be implemented, for example, using the system architecture illustrated in FIG. 1 and described herein, although other systems and architectures can be used in other embodiments, as will be apparent in light of this disclosure. To this end, the correlation of the various functions illustrated in FIG. 2 to the specific components, systems, or sub-modules illustrated in FIG. 1 is not intended to imply any structural and/or use limitations. Rather other embodiments may include, for example, varying degrees of integration where multiple functionalities are effectively performed by one user, system, or sub-module. For example, in certain embodiments content authoring tools 410 also include the content simulation functionality associated with content simulation tools 430, or alternatively, the content simulation functionality is provided by content server 200 itself. Thus other embodiments may have fewer or more components and/or systems depending on the granularity of a particular implementation. Numerous variations and alternative configurations will therefore be apparent in light of this disclosure.

As illustrated in FIG. 2, method 1000 commences with content author 400 using content authoring tools 410 to generate, modify, or otherwise manage content. See reference numeral 1410 in FIG. 2. This may encompass, for example, importing previously authored content from an external source and/or reviewing previously authored content, regardless of the source. Tag definition interface 420 can be used to define tag metadata corresponding to a selected content item. See reference numeral 1420 in FIG. 2. The tag metadata preferably provides some indication of the subject matter contained within the corresponding content item, such that a content consumer who performs operations based on targeted content tags or content exclusion tags will find or exclude appropriate content. Content tagging allows content author 400 to define market segments that are correlated to particular content items or collections of content items. This effectively enables content author 400 to serve targeted content to such market segments based directly on content consumers' self-designation of their likes and dislikes, thereby providing a more efficient and direct link between a content consumer's interests and the content which is served based on such interests. It also provides content author 400 with an opportunity to more specifically tailor certain content items based on observed market segments which can be characterized by common interests or disinterests.

For example, if a news article describing the upcoming passing of Halley's Comet is associated with a metadata tag “comet”, a content consumer who applies a targeted content tag “comet” to a search query will be more likely to find the aforementioned article. Likewise, a content consumer who applies a content exclusion tag “comet” to a search query will be less likely to find the aforementioned article. In certain embodiments, such as where imported content already includes metadata tags which are representative of the subject matter of the content, such tag metadata need not be defined again.

In some cases content author 400 can separately define tags that can be used for content targeting and tags that can be used for content exclusion. Returning to the example of the news article describing the upcoming passing of Halley's Comet, the content author could designate “comet” as a tag specifically intended to be applied for content targeting, and “astronomy” as a tag specifically intended to be applied for content exclusion. In this case, a content consumer who applies a targeted content tag “comet” to a search query will be more likely to find the Halley's Comet article, but a content consumer who applies a targeted content tag “astronomy” to a search query will not be any more likely to find the Halley's Comet article. Likewise, content consumers who apply a content exclusion tag comprising either “comet” or “astronomy” to a search query will be less likely to find the Halley's Comet article.

Content authoring tools 410 can be configured to store tagged content in authored content repository 440. See reference numeral 1412 in FIG. 2. Once appropriate metadata tags have been defined, content simulation tools 430 can be used to define a market segment (see reference numeral 1430 in FIG. 2) and simulate content rendering for the defined market segment (see reference numeral 1435 in FIG. 2). For example, a content author who is managing a website devoted to Major League Baseball may wish to see how the appearance of the website changes when a content consumer browses the website content after setting “Hall of Fame” as a content exclusion tag. Based on such simulation, the content author can generate new webpages specifically configured for content consumers who have set “Hall of Fame” as a content exclusion tag and can tag those new pages so as to increase the likelihood that consumers disinterested in the Hall of Fame see such pages. Content author 400 can also simulate how different combinations of exclusion tags affect the appearance of rendered content. More generally, certain of the embodiments disclosed herein can be understood as providing a content author with the ability to simulate how content will appear to a particular market segment (as defined by a content exclusion tag, for example) and then to generate targeted content for that market segment (which would be associated with the same content exclusion tag). Existing content delivery systems are not well suited for targeting content consumers based on things in which they have an expressed disinterest. While content simulation tools 430 provide a powerful results to help content authors better adapt their content for a particular target audience, it will be appreciated that in certain embodiments content author 400 may elect to forego any such content simulation.

Referring still to FIG. 2, once content author 400 is satisfied with particular content, for example based on a simulated rendering of the content, a determination can be made with respect to whether such content is ready for publication. See reference numeral 1414 in FIG. 2. If not, the content can be further modified, the tag metadata can be adjusted, and/or another simulation can be performed. If the content is ready for publication, content creation device 400 can be configured to publish the content, including any tag metadata, to content server 200. See reference numeral 1416 in FIG. 2. The published content can be stored in published content repository 230 hosted by content server 200.

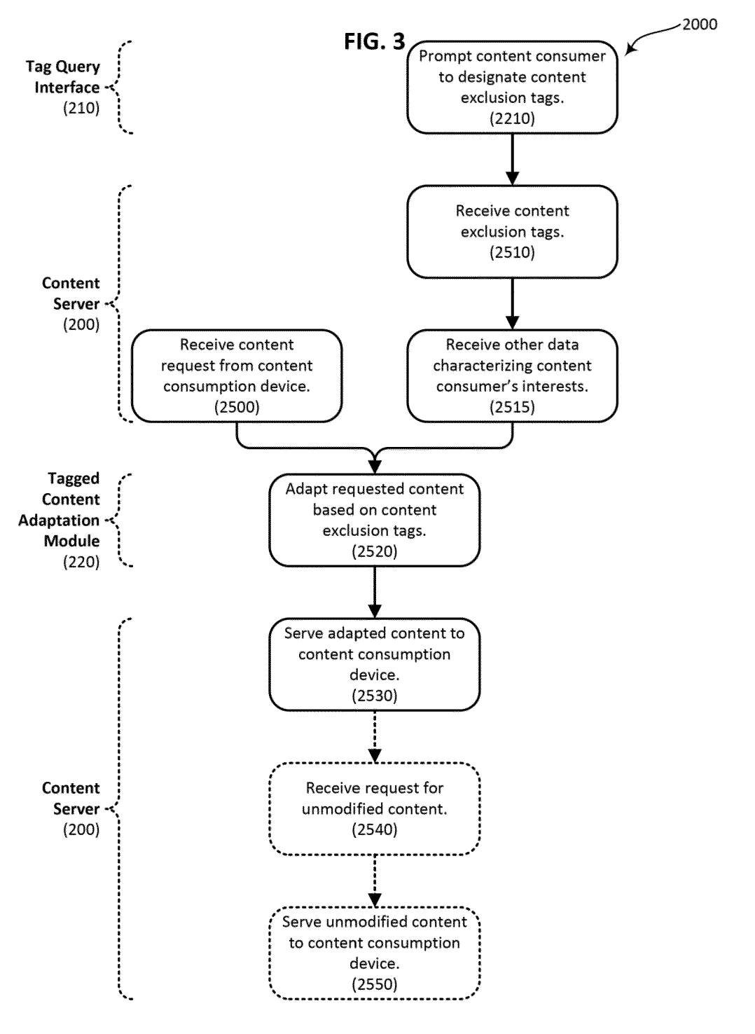

FIG. 3 is a flowchart illustrating an example method 2000 of serving content to a target audience, wherein the served content is selected based on subject matter tags associated with the target audience. As can be seen, this example methodology includes a number of phases and sub-processes, the sequence of which may vary from one embodiment to the next. However, when considered in the aggregate, these phases and sub-processes form a complete content consumption functionality that is responsive to user commands in accordance with certain of the embodiments disclosed herein. This methodology and its variants can be implemented, for example, using the system architecture illustrated in FIG. 1 and described herein, although other systems and architectures can be used in other embodiments, as will be apparent in light of this disclosure. To this end, the correlation of the various functions illustrated in FIG. 3 to the specific components, systems, or sub-modules illustrated in FIG. 1 is not intended to imply any structural and/or use limitations. Rather other embodiments may include, for example, varying degrees of integration where multiple functionalities are effectively performed by one user, system, or sub-module. For example, in certain embodiments a single sub-module is configured to (a) prompt a content consumer for targeted content and/or content exclusion tags and (b) adapt content requested by the content consumer based on one or more of such tags. Thus other embodiments may have fewer or more components and/or systems depending on the granularity of a particular implementation. Numerous various and alternative configurations will therefore be apparent in light of this disclosure.

As illustrated in FIG. 3, in certain embodiments method 2000 commences with content server 200 receiving a content request from content consumption device 100. See reference numeral 2500 in FIG. 3. For example, in an embodiment where content server 200 comprises a news aggregator, content server 200 may receive a request to provide a listing of news articles published within the last hour. As another example, in an embodiment where content server 200 comprises an online shopping portal, content server 200 may receive a request to provide a listing of current promotions. The request for content may therefore comprise a request for a particular content item or may more generally comprise a request to access a content portal, search engine, or other resource from which further content can be accessed.

Tag query interface 210 can be configured to prompt content consumer 100 to designate one or more tags, such as one or more content exclusion tags and/or one or more targeted content tags. See reference numeral 2210 in FIG. 3. Such a prompt may occur before receiving the content request from content consumer 100, and thus in certain embodiments method 2000 commences in this way. However, in other embodiments tag query interface 210 can be configured to prompt content consumer 100 to designate tags after content server 200 receives a content request from content consumer 100.

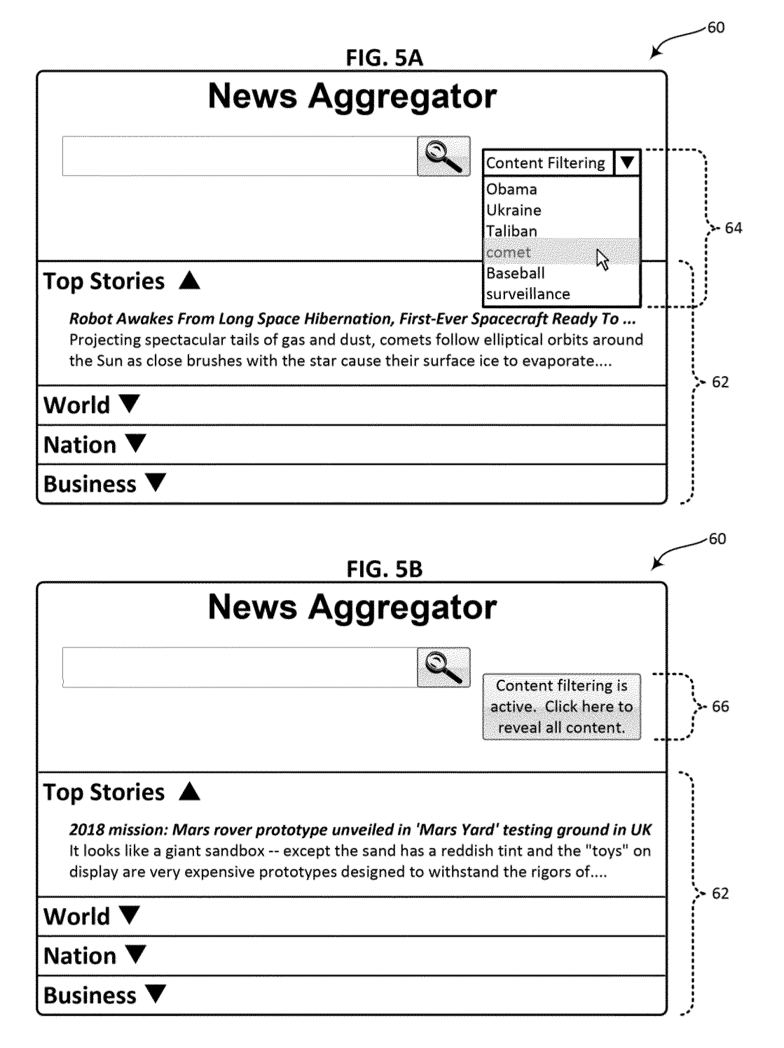

In still other embodiments, tag query interface 210 can be configured to prompt content consumer 100 to designate tags after content server 200 receives a content request and serves unfiltered content to content consumer 100 in response to such request. In such case the unfiltered content may include an annotation or other visual cue indicating that content filtering is available and prompting content consumer 100 to designate content exclusion tags if such filtering is desired. For instance, FIG. 5A illustrates an example user interface 60 that content consumer 100 can use to define content exclusion tags which may form the basis for content filtering in a news aggregator. User interface 60 includes a categorized listing of content items 62 which correspond to various news articles retrieved by the news aggregator. User interface 60 also includes a drop-down selection element 64, the presence of which indicates to content consumer 100 that tag-based content filtering is available for the displayed content items 62. In particular, selection element 64 allows content consumer 100 is view and select from a list of metadata tags corresponding to the various content items 62. Content consumer 100 can select a tag from this list to indicate subject matter which should be excluded from the listing of content items 62.

FIG. 5B illustrates the example user interface 60 of FIG. 5A wherein content displayed in the news aggregator has been filtered based on a user-defined content exclusion tag. In particular, the content consumer's selection of the content exclusion tag “comet” has caused a news article relating to comets to be removed from the listing of content items 62 in FIG. 5B. In addition, the user interface 60 of FIG. 5B includes an annunciator 66 indicating that the displayed content has been filtered. In certain embodiments annunciator 66 comprises an active user interface element, such that content consumer 100 can select annunciator 66 to cancel the filter and view all available content items.

Regardless of when content consumer 100 is prompted to designate tag, such a prompt can be configured to allow free-form textual input, as enabled by consumer tag receipt module 212. The prompt can additionally or alternatively be configured to display a list of available tags from which content consumer 100 can choose, as enabled by author tag display module 214. Such a configuration is particularly useful in embodiments where content consumer 100 is prompted to designate tags after submitting a content request to content server 200, in which case author tag display module 214 can be configured to display a list of tags associated with the requested or received content, including tags defined by content author 400. See, for example, user interface 60 in FIG. 5A. Furthermore, regardless of how content consumer 100 is prompted to designate the tags, in a modified embodiment tag query interface 210 can be configured to distinguish between targeted content tags and content exclusion tags designated by content consumer 100.

In embodiments where content consumer 100 designates tags, content server 200 can be configured to receive the designated tags, which may optionally include one or more content exclusion tags. See reference numeral 2510 in FIG. 3. Content server 200 can additionally or alternatively be configured to receive other data characterizing interests of content consumer 100. See reference numeral 2515 in FIG. 3. Examples of such data include browser cookie data 185 and data extracted from a user profile. User profile data can be received from content consumer 100 or from another source, such as a separate server configured to provide user account management functionality. For instance, in one embodiment user profile data is automatically and transparently provided to content server when content consumer 100 logs into a website that stores such data as part of a user account. Thus, from the consumer's perspective, simply logging into a website causes content subsequently provided by the website to be filtered according to the consumer's preference. Thus it will be appreciated that, in general, the data characterizing the interests of content consumer 100, including the consumer-designated tags themselves, can be received from a variety of different sources configured to store such data.

Once a content request and data characterizing the interests of content consumer 100 have been received, tagged content adaptation module 220 can be configured to adapt the requested content based on such data. In some cases the requested content can be adapted based on content exclusion tags designated by content consumer 100. See reference numeral 2520 in FIG. 3. In certain embodiments such adaptation may consist of reviewing content requested by content consumer 100 and removing content having tag metadata that matches or otherwise corresponds to a content exclusion tag provided by content consumer 100. This may involve, for example, removing certain content items that would otherwise be included in a listing of search results, or removing a banner advertisement that relates to subject matter in which content consumer 100 is uninterested. This may also involve substituting alternate content for the removed content. In some cases the alternate content optionally relates to subject matter which content consumer 100 has affirmatively expressed an interest in, while in other cases the alternate content relates to subject matter which content consumer 100 is inferred to be interested in based on other collected data. In other embodiments adaptation of the requested content may consist of demoting content items having tag metadata that matches or otherwise corresponds to a content exclusion tag provided by content consumer 100, such that the demoted content items appear lower in a listing of search results, for example.

In general, adapting the requested content as disclosed herein advantageously allows content consumer 100 to control how requested content is rendered. This is particularly useful in the context of content provided by a search engine, which will often consist of a listing of search results, many of which might not be of interest to content consumer 100. Application of one or more content exclusion tags could cause the listing of search results to more closely align with the interests of content consumer 100. Such content adaption is also particularly useful in the context of content provided by a news aggregation service, which again will often compile news content which is not of interest to content consumer 100. This is especially likely to occur where a particular content consumer is not interested in a news story which is otherwise generally popular, and which would therefore tend to dominate a news feed. Again, application of one or more content exclusion tags to the news feed helps content consumer 100 avoid having to scroll through large quantities of uninteresting news articles to find articles which more closely align with the consumer's interests. This provides content consumer 100 with a better impression of the content provided by content server 200 which can, in turn, promote loyalty to a given website, portal, or other information resource. This is advantageous to content consumers and administrators alike.

Content server 200 can serve adapted content to content consumption device 100. See reference numeral 2530 in FIG. 3. The adapted content optionally includes an annotation or other visual cue indicating that content filtering has occurred and providing content consumer 100 with a way to cancel such filtering and view the unfiltered content. Thus in certain embodiments method 2000 optionally further comprises receiving, by content server 200, a request for content that is unfiltered or otherwise unmodified. See reference numeral 2540 in FIG. 3. Content server 200 can be configured to respond to such a request by serving the unmodified content to content consumption device 100. See reference numeral 2550 in FIG. 3.

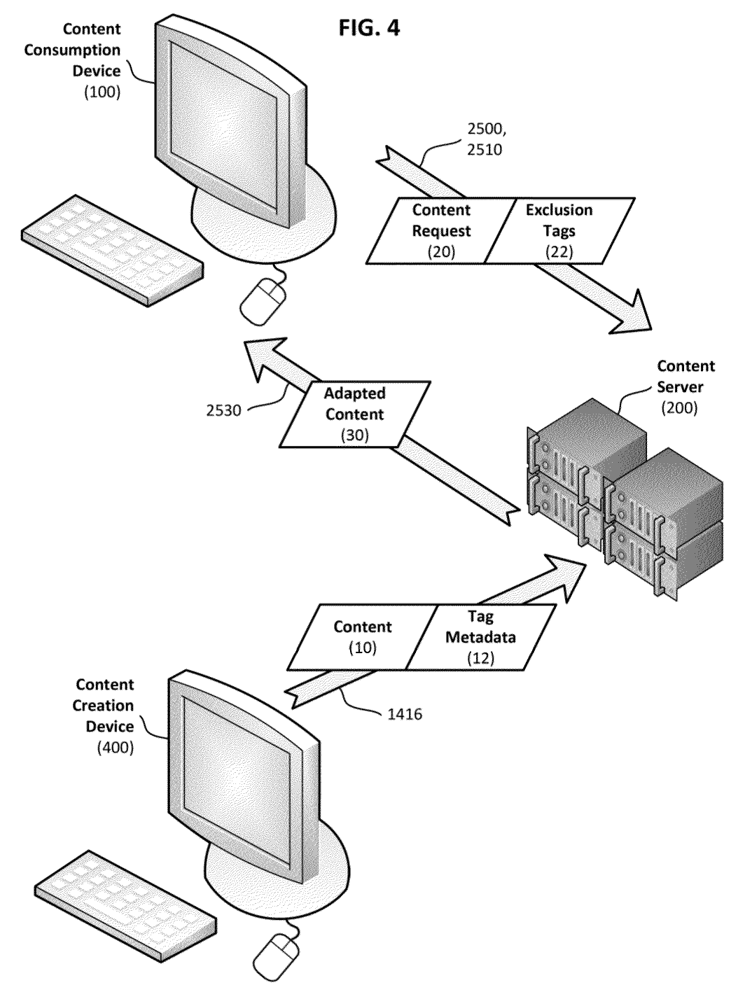

FIG. 4 is a data flow diagram schematically illustrating an example method of delivering content that has been adapted for a target audience based on correlation of tag metadata provided by a content author with exclusion tags provided by a content consumer. This method may correspond to the content authoring method 1000 illustrated in FIG. 2 and the content consumption method 2000 illustrated in FIG. 3. Content author 400 provides content 10 and corresponding tag metadata 12 to content server 200. Publication of the tagged content 10 is indicated by reference numeral 1416 in FIGS. 2 and 4. Content consumer 100 sends a content request 20 that includes one or more content exclusion tags 22 to content server 200. Receipt of content request 20 and one or more exclusion tags 22 is indicated by reference numerals 2500 and 2510 in FIGS. 3 and 4. Content server 200 may receive content request 20 from content consumer 100 before, after, or simultaneously with receipt of published content 10 from content author 400. Content server 200 is configured to adapt the published content 10 based correlations which are identified between tag metadata 12 and exclusion tags 22. Adapted content 30 can then be served to content consumer 100, as indicated by reference numeral 2530 in FIGS. 3 and 4.

In a modified embodiment, content request 20 is not necessarily accompanied by exclusion tags 22. That is, in certain applications a content consumer 100 viewing a previously served webpage may simply activate content filtering by clicking a link, icon, image, or other user interface element. In response, content consumption device 100 can be configured to request content to which one or more previously defined exclusion tags have been applied. Such previously-defined exclusion tags may be defined by, for example, content author 400, content consumer 100, or an intermediary such as a news aggregator or a search engine. In such embodiments the content consumer perceives the previously viewed content as simply being refreshed—and filtered—in response to selecting a user interface element. Such embodiments advantageously can provide a streamlined, “one-click” interface that allows the user to avoid setting content exclusion tags for individual websites or search queries.

### CONCLUSION

Numerous variations and configurations will be apparent in light of this disclosure. For example one example embodiment provides a method for targeted content delivery that comprises receiving, by a content server, a plurality of content items from one or more content authors. A particular content item is associated with a metadata tag representing subject matter provided within the particular content item. The method further comprises delivering, from the content server to a content consumer, a list comprising one or more metadata tags associated with the plurality of content items. The method further comprises receiving, from the content consumer, a content exclusion tag selected from the list of one or more metadata tags. The method further comprises compiling a subset of content items from the plurality of content items. The subset of content items does not include content items associated with metadata tags that correspond to the content exclusion tag. The method further comprises delivering, from the content server to the content consumer, the subset of content items. In some cases the method further comprises receiving, from the content consumer, a content exclusion tag provided via a free-form textual input. In some cases the method further comprises receiving, from the content consumer, browser cookie data from which a market segment corresponding to the content consumer can be identified, wherein compiling the subset of content items further comprises selecting content items from the plurality of content items which are targeted to the identified market segment. In some cases a plurality of content exclusion tags are received from the content consumer. In some cases the subset of content items is delivered via a network communication that conforms to a HTTP. In some cases the method further comprises delivering, from the content server to the content consumer, the plurality of content items before receiving the content exclusion tag from the content consumer. In some cases the method further comprises rendering, at a computer system associated with the content consumer, a user interface element displaying the list comprising one or more metadata tags. In some cases the content server is a news aggregator and the plurality of content items comprise a plurality of news articles. In some cases the metadata tag associated with the particular content item is defined by an author of the particular content item. In some cases the method further comprises providing a selected one of the plurality of content items to a contextual analysis engine, wherein the contextual analysis engine is configured to generate a metadata tag representing subject matter provided within the selected content item.

Another example embodiment of the present invention provides a targeted content delivery system that comprises a published content repository configured to store a plurality of content items received from one or more content authors. Certain content items are associated with tag metadata representing subject matter provided within the corresponding certain content items. The system further comprises a tag query interface configured to receive a content exclusion tag associated with a content consumer. The system further comprises a tagged content adaptation module configured to compile a subset of content items from the plurality of content items. The subset of content items does not include content items associated with tag metadata that corresponds to the content exclusion tag. The system further comprises a content server configured to deliver the subset of content items to the content consumer. the tag query interface further comprises a consumer tag receipt module configured to receive the content exclusion tag based on input received from the content consumer. In some cases the content server is configured to deliver the plurality of content items to the content consumer before delivering the subset of content items. In some cases the system further comprises a contextual analysis engine that is configured to analyze a particular one of the plurality of content items and generate tag metadata associated with the particular content item. In some cases the tag query interface is configured to receive the content exclusion tag based on an analysis of a user profile corresponding to the content consumer. In some cases the tag query interface is configured to receive the content exclusion tag based on an analysis of browser cookie data obtained from the content consumer.

Another example embodiment of the present invention provides a non-transitory computer readable medium having instructions encoded thereon that, when executed by one or more processors cause a targeted content authoring process to be carried out. The process comprises storing a plurality of content items in an authored content repository. The process further comprises receiving tag metadata associated with each of the plurality of content items. The process further comprises receiving a content exclusion tag specified by a content consumer. The process further comprises performing a simulation of an adaptation of the plurality of content items by applying the content exclusion tag to the plurality of content items. The adaptation causes unwanted content items associated with tag metadata that corresponds to the content exclusion tag to not be rendered during the simulation. The process further comprises updating the tag metadata based the simulation of the adaption of the plurality of content items. In some cases the simulation causes a portion of, but not all of, the plurality of content items to be rendered. In some cases the process further comprises publishing the plurality of content items and the updated tag metadata to a content server. In some cases the process further comprises publishing the plurality of content items to a web server that maintains user account data corresponding to the content consumer, the user account data including the content exclusion tag.

The foregoing description of selected embodiments has been presented for purposes of illustration and description. It is not intended to be exhaustive or to limit the invention to the precise form described. Many modifications and variations are possible in light of this disclosure. Therefore it is intended that the scope of the invention be limited not by this detailed description, but rather by the claims appended hereto.

What is claimed is:

1. A method for targeted content delivery, the method comprising:
receiving, by a content server, a plurality of content items from one or more content authors, wherein a particular content item is associated with a metadata tag representing subject matter provided within the particular content item;
delivering, from the content server to a content consumer, a list comprising one or more metadata tags associated with the plurality of content items;
receiving, from the content consumer, a content exclusion tag selected from the list of one or more metadata tags;
compiling a subset of content items from the plurality of content items, wherein the subset of content items does not include content items associated with metadata tags that correspond to the content exclusion tag; and
delivering, from the content server to the content consumer, the subset of content items.

2. The method of claim 1, further comprising receiving, from the content consumer, a content exclusion tag provided via a free-form textual input.

3. The method of claim 1, further comprising:
receiving, from the content consumer, browser cookie data from which a market segment corresponding to the content consumer can be identified;
wherein compiling the subset of content items further comprises selecting content items from the plurality of content items which are targeted to the identified market segment.

4. The method of claim 1, wherein a plurality of content exclusion tags are received from the content consumer.

5. The method of claim 1, wherein the subset of content items is delivered via a network communication that conforms to a hypertext transfer protocol (HTTP).

6. The method of claim 1, further comprising delivering, from the content server to the content consumer, the plurality of content items before receiving the content exclusion tag from the content consumer.

7. The method of claim 1, further comprising rendering, at a computer system associated with the content consumer, a user interface element displaying the list comprising one or more metadata tags.

8. The method of claim 1, wherein the content server is a news aggregator and the plurality of content items comprise a plurality of news articles.

9. The method of claim 1, wherein the metadata tag associated with the particular content item is defined by an author of the particular content item.

10. The method of claim 1, further comprising providing a selected one of the plurality of content items to a contextual analysis engine, wherein the contextual analysis engine is configured to generate a metadata tag representing subject matter provided within the selected content item.

11. A targeted content delivery system comprising:
a published content repository configured to store a plurality of content items received from one or more content authors, wherein certain content items are associated with tag metadata representing subject matter provided within the corresponding certain content items;
a tag query interface configured to receive a content exclusion tag associated with a content consumer;
a tagged content adaptation module configured to compile a subset of content items from the plurality of content items, wherein the subset of content items does not include content items associated with tag metadata that corresponds to the content exclusion tag; and
a content server configured to deliver the subset of content items to the content consumer.

12. The system of claim 11, wherein the tag query interface further comprises a consumer tag receipt module configured to receive the content exclusion tag based on input received from the content consumer.

13. The system of claim 11, wherein the content server is configured to deliver the plurality of content items to the content consumer before delivering the subset of content items.

14. The system of claim 11, further comprising a contextual analysis engine that is configured to analyze a particular one of the plurality of content items and generate tag metadata associated with the particular content item.

15. The system of claim 11, wherein the tag query interface is configured to receive the content exclusion tag based on an analysis of a user profile corresponding to the content consumer.

16. The system of claim 11, wherein the tag query interface is configured to receive the content exclusion tag based on an analysis of browser cookie data obtained from the content consumer.

17. A non-transitory computer readable medium having instructions encoded thereon that, when executed by one or more processors cause a targeted content authoring process to be carried out, the process comprising:
storing a plurality of content items in an authored content repository;
receiving tag metadata associated with each of the plurality of content items;
receiving a content exclusion tag specified by a content consumer;
performing a simulation of an adaptation of the plurality of content items by applying the content exclusion tag to the plurality of content items, wherein the adaptation causes unwanted content items associated with tag metadata that corresponds to the content exclusion tag to not be rendered during the simulation; and
updating the tag metadata based the simulation of the adaption of the plurality of content items.

18. The non-transitory computer readable medium of claim 17, wherein the simulation causes a portion of, but not all of, the plurality of content items to be rendered.

19. The non-transitory computer readable medium of claim 17, the process further comprising publishing the plurality of content items and the updated tag metadata to a content server.

20. The non-transitory computer readable medium of claim 17, the process further comprising publishing the plurality of content items to a web server that maintains user account data corresponding to the content consumer, the user account data including the content exclusion tag.
